(19) United States
(12) Patent Application Publication
(10) Pub. No.: US 2025/0346017 A1
(43) Pub. Date: Nov. 13, 2025

(54) COMPOSITE MATERIALS FOR ROOFING APPLICATIONS

(71) Applicant: Neenah, Inc., Alpharetta, GA (US)

(72) Inventors: Rebecca Wilson, Stalybridge (GB); Geoffrey Henstock, Greater Manchester (GB)

(21) Appl. No.: 19/198,217

(22) Filed: May 5, 2025

Related U.S. Application Data
(60) Provisional application No. 63/644,557, filed on May 9, 2024.

(51) Int. Cl. B32B 5/02; B32B 7/06; B32B 7/12; B32B 25/04; B32B 27/06; B32B 37/12; B32B 37/16

(52) U.S. Cl. CPC B32B 5/022; B32B 7/06; B32B 7/12; B32B 25/04; B32B 27/06; B32B 37/12; B32B 37/16; B32B 2262/124; B32B 2264/1021; B32B 2264/104; B32B 2270/00; B32B 2307/3065; B32B 2307/536; B32B 2307/712; B32B 2419/06

(57) ABSTRACT

Composite materials and methods for making such materials are provided. These materials may be particularly useful as roofing materials for flat or low sloped roofs to protect the roof and building from water, heat, fire or other elements. A composite material comprises a water resistant layer comprising a polymer and a filler material incorporated into the water resistant layer. The filler material comprises a flame retardant material that limits heat transfer therethrough. This provides a watertight seal for a structure, such as a roof, while also providing adequate protection against fire or other sources of heat that may damage the building. The composite material may further include a non-woven layer bonded to the water resistant layer with a temperature sensitive adhesive to form a membrane roofing substrate.

### CROSS-REFERENCE TO RELATED APPLICATIONS

This application claims the benefit of U.S. Provisional Application Ser. No. 63/644,557, filed May 9, 2024, the complete disclosure of which is incorporated herein by reference for all purposes.

### TECHNICAL FIELD

This description generally relates to composite materials that reduce heat transfer and more particularly to roofing materials for use on flat or low sloped roofs that include flame retardants and/or heat resistant materials.

### BACKGROUND

Continuous sheet roofing products have been used extensively in commercial and residential building applications which involve large roof expanses, particularly with flat or shallow pitched roofs. This popularity of sheet roofing is due to a variety of factors, including convenience and speed of installation, reduced material and labor costs and longevity and reliability of the installed roof. Many sheet roofing products include synthetic rubber or thermoplastic sheets which are applied from rolls and attached to the roof via a variety of adhesives and fasteners

Membrane roofing is a type of roofing system for buildings that creates a continuous watertight covering to protect the interior of a building. Membrane roofs are most commonly made from cured or uncured elastomers, plastomers (e.g., thermoplastics) or modified bitumen, or modified bitumen.

Membrane roofs provide distinct advantages over the previously more common flat roofing method of asphalt and gravel (commonly referred to as Built-Up-Roofs or “BUR”). In asphalt and gravel applications, for example, it can be very difficult to create a proper seal at all seams and connection points. This can cause a roof to leak early in its lifespan, and require much more maintenance. When installed correctly, newer materials are either seamless, or have seams as strong as the body. This eliminates most of the leakage concerns associated with flat roofing systems.

While these membrane roofs provide a number of advantages, it would be further beneficial to provide materials that have the watertight benefits of membrane roofing materials, while also providing adequate protection against fire or other sources of heat that may damage the building.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Composite materials and methods for making such composite materials are provided. These materials may be particularly useful as roofing materials for flat or low sloped roofs to protect the roof and building or other structure from water, heat, fire or other elements.

In one aspect, a composite material comprises a water resistant layer comprising a polymer and a filler material incorporated into the water resistant layer. The filler material comprises a flame retardant material that limits heat transfer therethrough. This provides a watertight seal of a structure or substrate, such as a roof, while also providing adequate protection against fire or other sources of heat that may damage the building.

In embodiments, the polymer comprises an elastomer that provides sufficient water resistance to maintain an adequate watertight seal. Suitable elastomers for use in the composite material include synthetic or natural rubbers, ethylene propylene diene monomer rubber (EPDM), butyl rubber, polyisobutylene (PIB), polyvinyl chloride (PVC), thermoplastic polyolefin (TPO) or combinations thereof. In an exemplary embodiment, the polymer comprises PIB.

In embodiments, the filler material comprises a material suitable for resisting heat transfer and/or retarding flames. In certain embodiments, the filler material comprises fibers that are mixed with the elastomer to form the water resistant layer. Suitable filler materials for use with the composite material include melamine, melamine polyphosphate, aluminum trihydroxide, antimony trihydroxide, phosphorous, ammonium polyphosphate, halogenated organic materials, PBDE, TBBPA, mica and mica derivatives, vermiculite and vermiculite derivatives, polybutylene terephthalate, chalk, silica, or combinations thereof. In an exemplary embodiment, the filler material comprises aluminum trihydroxide or a combination of chalk and silica.

In embodiments, the composite material further includes a non-woven layer bonded to the water resistant layer. The non-woven layer may comprise a fleece, felt or other suitable material for contacting a substrate or structure, such as a roof substrate.

The composite material may further comprise an adhesive between the non-woven layer and the water resistant layer. The adhesive may comprise a temperature resistant adhesive and at least some of the adhesive may be disposed within the non-woven layer to bond the composite material to a substrate or structure, such as a roof substrate. Suitable temperature resistant adhesives include butyl glue, hot melt adhesives, silicone glue and the like.

The composite material may include a release liner removably coupled to the water resistant layer. The release liner allows the composite material to be handled prior to adhering it to the roof substrate.

In certain embodiments, the water resistant layer further comprises a polymer having a percentage of total weight of the water resistant layer that provides a sufficient hardness to the water resistant layer to allow the layer to be walked on without being substantially indented. In certain embodiments, the hardness of the water resistant layer is at least about 60 Shore O. In an exemplary embodiment, the hardness is at least about 78 Shore O.

The polymer is preferably about 40% to about 75%, or about 50% to about 60% percent by weight of the overall water resistant layer. Suitable polymers include ultra-low density polyethylene (ULDPE), low density polyethylene (LDPE), high density polyethylene (HDPE), polypropylene (PP), polyvinyl chloride and vinyl derivatives, polystyrene, polyethylene terephthalate (polyester), polyamides or combinations thereof. In an exemplary embodiment, the polymer comprises ULDPE.

In another aspect, a method for making a composite material comprises providing fibers of a flame retardant filler material and mixing the fibers with a polymer to form a water resistant layer. The polymer may comprise an elastomer that provides sufficient water resistance to maintain an adequate watertight seal.

In embodiments, the fibers and the elastomer are ground together with one or more moving blades through a shearing process. In an exemplary embodiment, the fibers and elastomer are mixed together in a robust mixing device, such as a Branbury mixer or the like, that includes a series of rams and rotators that provide the mixing action and compresses the fibers into the polymer to form the water resistant layer.

In one embodiment, a polymer, such as ULDPE or the like, is mixed and ground together with the fibers and the elastomer in the same process. Alternatively, the polymer may be added to the water resistant layer after the fibers and elastomer have been mixed together.

In certain embodiments, the fibers and the polymers may be extruded together to form the water resistant layer. In one embodiment, the extrusion occurs after the mixing described above. In another embodiment, the extrusion replaces the mixing step and serves to mix the elastomer with the fibers into the water resistant layer. In this embodiment, the method further comprises mixing a plasticizer with the fibers and the polymer to facilitate extrusion of the elastomer. Once the fibers are suitably mixed with the elastomer, the composite may be calendared to form a moderately incompressible layer.

In certain embodiments, the method further comprises bonding a non-woven layer to the water resistant layer. The layers may be bonded together with, for example, a temperature resistant adhesive.

In embodiments, a release liner may be removably coupled to the water resistant layer. The release liner allows the composite material to be handled prior to adhering it to the roof substrate.

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 is a schematic of the layers of a composite material for a structure, such as a roof; and

FIG. 2 illustrates the composite material of FIG. 1 with the layers bonded to each other.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Composite materials are provided for resisting heat transfer through the material. These materials may be particularly useful as waterproof sheeting layers or membranes for covering roof substrates on flat or low sloped roofs. The composite materials may, for example replace lead for roofing materials and/or may be used for flashing waterproof areas.

In conventional roofing materials, the water resistant elastomer layer typically provides little to no resistance to heat transferring through the membrane. Thus, these membrane roofs are not as fire resistant as conventional asphalt, gravel, concrete, slate or metal roofing materials and, therefore, do not provide adequate protection from embers, firebrands, radiant heat exposure or direct flame contact. The composite materials provided herein have a watertight seal of a structure or substrate, such as a roof, while also providing adequate protection against fire or other sources of heat that may damage the building.

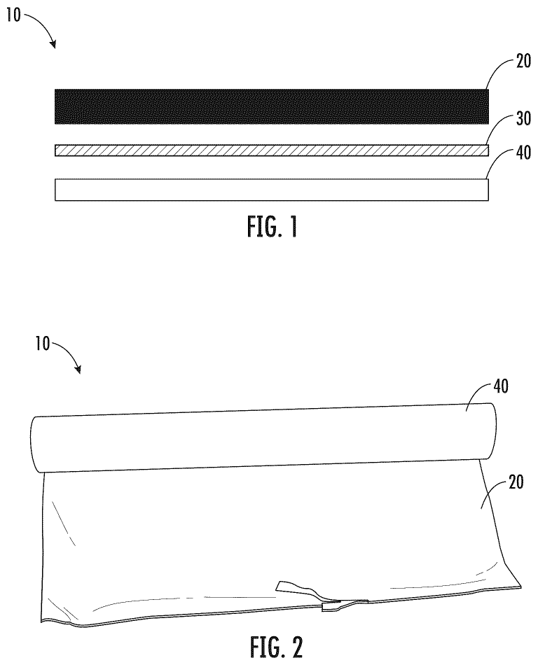

Referring now to FIGS. 1 and 2, a composite material 10 for roofing substrates comprises a water resistant layer 20. In some embodiments, the material 10 may further comprise an adhesive layer 30 and a non-woven layer 40. The adhesive layer 30 bonds non-woven layer 40 to water resistant layer 20. In other embodiments, composite material 10 does not comprise the non-woven layer 40.

Water resistant layer 20 comprises an elastomer that provides sufficient water resistance to maintain an adequate watertight seal. Suitable elastomers for use in the composite material include synthetic or natural rubbers, ethylene propylene diene monomer rubber (EPDM), butyl rubber, polyisobutylene (PIB), polyvinyl chloride (PVC), thermoplastic polyolefin (TPO) or combinations thereof. I

In an exemplary embodiment, the polymer comprises PIB. The PIB layer may have a thickness of about 1 mm to about 2 mm, preferably about 1.3 mm.

The water resistant layer 20 further includes one or more filler materials incorporated therein. The filler material(s) comprise a flame retardant material that limits heat transfer therethrough. The filler material is typically about 25% to about 60%, or about 40% to about 50% percent by weight of the water resistant layer.
Suitable filler materials for use with the composite material include melamine, melamine polyphosphate, aluminum trihydroxide, antimony trihydroxide, chalk, silica, phosphorous, ammonium polyphosphate, halogenated organic materials, PBDE, TBBPA, mica and mica derivatives, vermiculite and vermiculite derivatives, polybutylene terephthalate, chalk, silica, or combinations thereof. In an exemplary embodiment, the filler material comprises aluminum trihydroxide or a combination of chalk and silica.

In one embodiment, the filler material comprises chalk and silica.

The adhesive is preferably a weather, aging, and temperature resistant adhesive, and may have a thickness of about 0.05 mm to about 0.2 mm, preferably about 0.1 mm. Suitable temperature resistant adhesives include butyl glue, hot melt adhesives, silicone glue and the like. A suitable butyl glue for use herein is manufactured by Isoltema Group, with headquarters in Gambettoia (FC), Italy.

The adhesive may include pigments that impart viscosity and mechanically reinforce the cured adhesive. The adhesive may also include a plasticizer to impart elastomeric properties to the cured adhesive.

The non-woven layer preferably comprises a material that is durable, resistant to fraying and relatively easy to cut. Suitable non-woven layers include fleece, felt or the like. The non-woven layer may have a thickness of about 0.5 to about 2 mm, preferably about 1 mm.

The composite material may include a release liner removably coupled to the water resistant layer. The release liner allows the composite material to be handled prior to adhering it to the roof substrate. Suitable release liners include polyvinyl chloride (PVC), polyethylene, low density polyethylene (LDPE) and the like.

In certain embodiments, the water resistant layer further comprises a polymer having a percentage of total weight of the water resistant layer that provides a sufficient hardness to the water resistant layer. This may, for example, allow the layer to be walked on without being indented. In certain embodiments, the hardness of the water resistant layer is at least about 60 Shore O. In an exemplary embodiment, the hardness is at least about 78 Shore O.

The polymer is preferably about 40% to about 75%, or about 50% to about 60% percent by weight of the overall water resistant layer. Suitable polymers include ultra-low density polyethylene (ULDPE), low density polyethylene (LDPE), high density polyethylene (HDPE), polypropylene (PP), polyvinyl chloride and vinyl derivatives, polystyrene, polyethylene terephthalate (polyester) and polyamides. In an exemplary embodiment, the polymer comprises ULDPE.

Methods for making the composite materials described above are also provided in this description. In one method, components of a flame retardant filler material are mixed with the elastomer to form the water resistant layer. These components may include, for example, powders, fibers, or other granulated materials. The powder and the polymer are ground together with one or more moving blades through a shearing process. In an exemplary embodiment, the powder and polymer are mixed together in a robust mixing device, such as a Branbury mixer or the like, that includes a series of rams and rotators that provide the mixing action and compress the powder into the polymer to form the water resistant layer.

The powder and the polymers may be extruded together to form the water resistant layer. In one embodiment, the extrusion occurs after the mixing described above. In another embodiment, the extrusion replaces the mixing step and serves to mix the elastomer with the powder into the water resistant layer. In this embodiment, the method further comprises mixing a plasticizer with the powder and the polymer to facilitate extrusion of the polymer. Once the powder is suitably mixed with the polymer, the composite may be calendared to form a moderately incompressible layer.

In certain embodiments, the method further comprises bonding a non-woven layer to the water resistant layer. The layers may be bonded together with, for example, a temperature resistant adhesive.

In embodiments, a release liner may be removably coupled to the water resistant layer. The release liner allows the composite material to be handled prior to adhering it to the roof substrate.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a composite material comprising a water resistant layer comprising a polymer and a filler material incorporated into the water resistant layer. The filler material comprises a flame retardant material that limits heat transfer therethrough.

A second embodiment is the first embodiment, wherein the polymer comprises an elastomer.

A third embodiment is any combination of the first two embodiments, wherein the polymer comprises a material selected from the group consisting of synthetic or natural rubbers, ethylene propylene diene monomer rubber (EPDM), butyl rubber, polyisobutylene (PIB), polyvinyl chloride (PVC) and thermoplastic polyolefin (TPO).

A 4^{th} embodiment is any combination of the first 3 embodiments, wherein the polymer comprises polyisobutylene (PIB).

A 5^{th} embodiment is any combination of the first 4 embodiments, wherein the filler material comprises a material selected from the group consisting of melamine, melamine polyphosphate, aluminum trihydroxide, antimony trihydroxide, chalk, silica, phosphorous, ammonium polyphosphate, halogenated organic materials, PBDE, TBBPA, mica and mica derivatives, vermiculite and vermiculite derivatives, polybutylene terephthalate and combinations thereof.

A 6^{th} embodiment is any combination of the first 5 embodiments, wherein the filler material comprises aluminum trihydroxide.

A 7^{th} embodiment is any combination of the first 6 embodiments, wherein the filler material comprises chalk, silica, or a combination thereof.

An 8^{th} embodiment is any combination of the first 7 embodiments, wherein the filler material comprises one or more fibers that are mixed into the PIB.

A 9^{th} embodiment is any combination of the first 8 embodiments, further comprising a non-woven layer bonded to the water resistant layer.

A 10^{th} embodiment is any combination of the first 9 embodiments, further comprising an adhesive between the non-woven layer and the water resistant layer.

An 11^{th} embodiment is any combination of the first 10 embodiments, wherein the non-woven layer comprises a material selected from the group consisting of fleece and felt.

A 12^{th} embodiment is any combination of the first 11 embodiments, wherein the adhesive comprises a temperature resistant adhesive.

A 13^{th} embodiment is any combination of the first 12 embodiments, wherein the adhesive comprises butyl glue.

A 14^{th} embodiment is any combination of the first 13 embodiments, further comprising a release liner removably coupled to the water resistant layer.

A 15^{th} embodiment is any combination of the first 14 embodiments, further comprising a second polymer in the water resistant layer, the second polymer selected from the group consisting of ultra-low density polyethylene (ULDPE), low density polyethylene (LDPE), high density polyethylene (HDPE), polypropylene (PP), polyvinyl chloride and vinyl derivatives, polystyrene, polyethylene terephthalate (polyester) and polyamides.

A 16^{th} embodiment is any combination of the first 15 embodiments, wherein the composite material has a hardness of at least about 60 Shore O.

A 17^{th} embodiment is any combination of the first 16 embodiments, wherein the composite material is configured for attachment to a structure.

An 18^{th} embodiment is any combination of the first 17 embodiments, wherein the structure is a roof of a building.

In another aspect, a first embodiment is a roof membrane comprising a water resistant layer comprising a polymer and a filler material incorporated into the water resistant layer. The filler material comprises a flame retardant material that limits heat transfer therethrough.

A second embodiment is the first embodiment, wherein the polymer comprises an elastomer.

A third embodiment is any combination of the first 2 embodiments, wherein polymer comprises a material selected from the group consisting of synthetic or natural rubbers, ethylene propylene diene monomer rubber (EPDM), butyl rubber, polyisobutylene (PIB), polyvinyl chloride (PVC) and thermoplastic polyolefin (TPO).

A 4^{th} embodiment is any combination of the first 3 embodiments, wherein the polymer comprises polyisobutylene (PIB).

A 5^{th} embodiment is any combination of the first 4 embodiments, wherein the filler material comprises a material selected from the group consisting of melamine, melamine polyphosphate, aluminum trihydroxide, antimony trihydroxide, phosphorous, ammonium polyphosphate, halogenated organic materials, PBDE, TBBPA, mica and mica derivatives, vermiculite and vermiculite derivatives, polybutylene terephthalate and combinations thereof.

A 6^{th} embodiment is any combination of the first 5 embodiments, further comprising a non-woven layer bonded to the water resistant layer.

A 7^{th} embodiment is any combination of the first 6 embodiments, wherein the filler material comprises aluminum trihydroxide.

An 8^{th} embodiment is any combination of the first 7 embodiments, wherein the filler material comprises chalk, silica, or a combination thereof.

A 9^{th} embodiment is any combination of the first 8 embodiments, wherein the filler material comprises one or more fibers that are mixed into the PIB.

A 10^{th} embodiment is any combination of the first 9 embodiments, further comprising a non-woven layer bonded to the water resistant layer.

An 11^{th} embodiment is any combination of the first 10 embodiments, further comprising an adhesive between the non-woven layer and the water resistant layer.

A 12^{th} embodiment is any combination of the first 11 embodiments, wherein the non-woven layer comprises a material selected from the group consisting of fleece and felt.

A 13^{th} embodiment is any combination of the first 12 embodiments, wherein the adhesive comprises a temperature resistant adhesive.

A 14^{th} embodiment is any combination of the first 13 embodiments, wherein the adhesive comprises butyl glue.

A 15^{th} embodiment is any combination of the first 14 embodiments, further comprising a release liner removably coupled to the water resistant layer.

A 16^{th} embodiment is any combination of the first 15 embodiments, further comprising a second polymer in the water resistant layer, the second polymer selected from the group consisting of ultra-low density polyethylene (ULDPE), low density polyethylene (LDPE), high density polyethylene (HDPE), polypropylene (PP), polyvinyl chloride and vinyl derivatives, polystyrene, polyethylene terephthalate (polyester) and polyamides.

A 17^{th} embodiment is any combination of the first 16 embodiments, wherein the water resistant layer has a hardness of at least about 60 Shore O.

In another aspect, a first embodiment is a method for making a composite material. The method comprises providing fibers of a flame retardant filler material and mixing the fibers with a polymer to form a water resistant layer.

A second embodiment is the first embodiment, wherein the fibers and the polymer are ground together with one or more moving blades.

A 3^{rd} embodiment is any combination of the first 2 embodiments, wherein the fibers and the polymer are ground together through a shearing process.

A 4^{th} embodiment is any combination of the first 3 embodiments, further comprising extruding the fibers and the polymer.

A 5^{th} embodiment is any combination of the first 4 embodiment, further comprising mixing a plasticizer with the fibers and the polymer.

A 6^{th} embodiment is any combination of the first 5 embodiments, further comprising calendaring the fibers and the polymer to form the water resistant layer.

A 7^{th} embodiment is any combination of the first 6 embodiments, further comprising bonding a non-woven layer to the water resistant layer.

An 8^{th} embodiment is any combination of the first 7 embodiments, wherein the polymer comprises an elastomer.

A 9^{th} embodiment is any combination of the first 8 embodiments, wherein the polymer comprises a material selected from the group consisting of synthetic or natural rubbers, ethylene propylene diene monomer rubber (EPDM), butyl rubber, polyisobutylene (PIB), polyvinyl chloride (PVC) and thermoplastic polyolefin (TPO).

A 10^{th} embodiment is any combination of the first 9 embodiments, wherein the filler material comprises a material selected from the group consisting of melamine, melamine polyphosphate, aluminum trihydroxide, antimony trihydroxide, phosphorous, ammonium polyphosphate, halogenated organic materials, PBDE, TBBPA, mica and mica derivatives, vermiculite and vermiculite derivatives, polybutylene terephthalate and combinations thereof.

An 11^{th} embodiment is any combination of the first 10 embodiments, further comprising removably coupling a release liner to the water resistant layer.

What is claimed is:

1. A composite material comprising:
a water resistant layer comprising a polymer; and
a filler material incorporated into the water resistant layer, the filler material comprising a flame retardant material that limits heat transfer therethrough.

2. The composite material of claim 1, wherein the polymer comprises an elastomer.

3. The composite material of claim 1, wherein the polymer comprises a material selected from the group consisting of synthetic or natural rubbers, ethylene propylene diene monomer rubber (EPDM), butyl rubber, polyisobutylene (PIB), polyvinyl chloride (PVC) and thermoplastic polyolefin (TPO).

4. The composite material of claim 1, wherein the polymer comprises polyisobutylene (PIB).

5. The composite material of claim 1, wherein the filler material comprises a material selected from the group consisting of melamine, melamine polyphosphate, aluminum trihydroxide, antimony trihydroxide, chalk, silica, phosphorous, ammonium polyphosphate, halogenated organic materials, PBDE, TBBPA, mica and mica derivatives, vermiculite and vermiculite derivatives, polybutylene terephthalate and combinations thereof.

6. The composite material of claim 1, wherein the filler material comprises aluminum trihydroxide.

7. The composite material of claim 1, wherein the filler material comprises chalk, silica, or a combination thereof.

8. The composite material of claim 1, wherein the filler material comprises one or more fibers that are mixed into the PIB.

9. The composite material of claim 1, further comprising a non-woven layer bonded to the water resistant layer.

10. The composite material of claim 9, further comprising an adhesive between the non-woven layer and the water resistant layer.

11. The composite material of claim 9, wherein the non-woven layer comprises a material selected from the group consisting of fleece and felt.

12. The composite material of claim 10, wherein the adhesive comprises a temperature resistant adhesive.

13. The composite material of claim 10, wherein the adhesive comprises butyl glue.

14. The composite material of claim 1, further comprising a release liner removably coupled to the water resistant layer.

15. The composite material of claim 1, further comprising a second polymer in the water resistant layer, the second polymer selected from the group consisting of ultra-low density polyethylene (ULDPE), low density polyethylene (LDPE), high density polyethylene (HDPE), polypropylene (PP), polyvinyl chloride and vinyl derivatives, polystyrene, polyethylene terephthalate (polyester) and polyamides.

16. The composite material of claim 1, wherein the composite material has a hardness of at least about 60 Shore O.

17. A roof membrane comprising:
a water resistant layer comprising a polymer; and
a filler material incorporated into the water resistant layer, the filler material comprising a flame retardant material that limits heat transfer therethrough.

18. The roof membrane of claim 17, wherein polymer comprises a material selected from the group consisting of synthetic or natural rubbers, ethylene propylene diene monomer rubber (EPDM), butyl rubber, polyisobutylene (PIB), polyvinyl chloride (PVC) and thermoplastic polyolefin (TPO).

19. The roof membrane of claim 17, wherein the polymer comprises polyisobutylene (PIB).

20. The roof membrane of claim 17, wherein the filler material comprises a material selected from the group consisting of melamine, melamine polyphosphate, aluminum trihydroxide, antimony trihydroxide, phosphorous, ammonium polyphosphate, halogenated organic materials, PBDE, TBBPA, mica and mica derivatives, vermiculite and vermiculite derivatives, polybutylene terephthalate and combinations thereof.
